(19) United States
(12) Patent Application Publication
(10) Pub. No.: US 2025/0308529 A1
(43) Pub. Date: Oct. 2, 2025

(54) REAL-TIME TRANSCRIPT PRODUCTION WITH DIGITAL ASSISTANT

(71) Applicant: Lenovo (United States) Inc., Morrisville, NC (US)

(72) Inventors: Tyler Nicholls, Lehi, UT (US); Inna Zolin, Cary, NC (US); Joshua Smith, Milton, FL (US); Matthew Fardig, Boonville, IN (US)

(21) Appl. No.: 18/619,794

(22) Filed: Mar. 28, 2024

(51) Int. Cl. G10L 15/26; G10L 15/06

(52) U.S. Cl. CPC G10L 15/26; G10L 15/063; G10L 2015/0638

(57) ABSTRACT

One embodiment provides a method, the method including: receiving, at a transcript production system, voice input, generated during a learning session, from a user, producing, from the received voice input and utilizing the transcript production system, a transcript of the received voice input; and performing, utilizing the transcript production system, an action with respect to the transcript as the transcript is produced. Other aspects are claimed and described.

### BACKGROUND

Many people learn during different learning sessions. Generally, during a learning session, an instructor, presenter, or other teacher, presents information to one or more students or groups of people. The teacher attempts to present the information in a manner that makes it understandable to the majority of the students within the learning session. The teacher may utilize presentation materials (e.g., textbooks, slide decks, whiteboards, videos, etc.) to assist in presenting material. However, the teacher generally relies on explaining a topic or subject by talking or providing some audible output. Audible output is hard to remember without recording the audible output, taking notes, or otherwise capturing the audible output in some form that the student is able to reference at a later time.

### BRIEF SUMMARY

In summary, one aspect provides a method, the method including: receiving, at a transcript production system, voice input, generated during a learning session, from a user; producing, from the received voice input and utilizing the transcript production system, a transcript of the received voice input; and performing, utilizing the transcript production system, an action with respect to the transcript as the transcript is produced.

Another aspect provides a system, the system including: a processor; a memory device that stores instructions that, when executed by the processor, causes the system to: receive, at a transcript production system, voice input, generated during a learning session, from a user; produce, from the received voice input and utilizing the transcript production system, a transcript of the received voice input; and perform, utilizing the transcript production system, an action with respect to the transcript as the transcript is produced.

A further aspect provides a product, the product including: a computer-readable storage device that stores executable code that, when executed by a processor, causes the product to: receive, at a transcript production system, voice input, generated during a learning session, from a user; produce, from the received voice input and utilizing the transcript production system, a transcript of the received voice input; and perform, utilizing the transcript production system, an action with respect to the transcript as the transcript is produced.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for producing a transcript of a received voice input and performing an action with respect to the transcript as the transcript is produced.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

While taking notes or otherwise recording audible output allows a student to later access some form of the audible output, it may not be the most effective way for either recalling what was actually taught or finding the provided information at a later time. For example, when taking notes, a note taker may take notes in a manner that makes sense at the time the audible output is provided. However, when later viewing or accessing the notes, without the context of the learning session, the notes may be unclear or prove to not provide enough information to allow the student to recall what was actually taught during the learning session.

Additionally, notes, recordings, or other traditional techniques for accessing audible output or a derivative form of the audible output is inefficient and usually relies on a memory or organization skills of the student. In other words, when a student is attempting to access material associated with audible output at a later time, the student usually has to figure out when the audible output related to the particular topic was provided and then attempt to find the notes, recordings, or other derivative form from a set of notes, recordings, or other derivative form that is usually associated with a series of learning sessions. For example, if a student is enrolled in a class that lasts a semester, the student may have notes, recordings, or other derivative forms of audible output for the entire semester. Remembering when a particular topic was presented may be difficult and may require the student to spend significant amounts of time looking for the notes for the particular topic from among all the notes taken for the entire semester. Otherwise, the student has to have the notes well organized which allows the student to find the desired topic quickly. However, even well-organized notes may still require the user to spend time searching for a particular concept.

An additional problem with traditional learning sessions is that the learning session is presented in a particular format using a particular style of the teacher or other presenter. While the teacher may tailor the instruction to be compatible with a majority of the students, it is difficult to make instruction understandable to every student or to tailor the instruction to every student's learning style. Additionally, since each teacher has their own teaching style, it may be difficult for the teacher to completely eliminate this style if students have difficulty learning from that style. Traditional techniques for addressing this usually require the student getting assistance outside of the classroom or requiring the teacher to spend a significant amount of time to create instruction for each individual student's needs. If a teacher has even just twenty students in a class, tailoring instruction to each individual student requires a significant amount of time and effort. Even if the teacher is able to tailor presentation materials and classroom work to each individual student, presenting the material in a classroom setting with a finite amount of time to teach the students results in not enough time to instruct the students using each technique that is required by each of the students within the learning session.

Accordingly, the described system and method provide a technique for producing a transcript of a received voice input and performing an action with respect to the transcript as the transcript is produced. The transcript production system receives voice input, generated during a learning session, from a user. In other words, as a teacher or other presenter is talking during a learning session, the transcript production system is ingesting the voice input. From the voice input, the transcript production system produces a transcript of the voice input. Thus, the system records the voice input in a text-based format.

The system can then perform an action with respect to the transcript, as the transcript in produced. The action that is performed varies with the end result that is desired by a user. For example, the action may simply include storing the transcript for later access. When storing the transcript, the system may perform analysis on the transcript that allows the transcript to be searched or topics within the transcript or group of transcripts to be found. For example, the system may perform text analysis to identify text and/or topics within the transcript or group of transcripts. The system may also utilize text analysis techniques to generate a summary from the transcript, which may be accessible by a student.

Another action may include dynamically altering the transcript to tailor the transcript to needs or preferences of a student or other person accessing the transcript. The transcript(s) may also be provided to an artificial intelligence model that can utilize the transcript(s) to provide new tools for students. For example, the artificial intelligence model can be used within a virtual assistant that can be accessed by students. As another example, the artificial intelligence model can alter the transcript to have different characteristics than the original transcript, for example, a different style, different written voice, different format, different formality, and/or the like. The transcripts, either as originally captured or altered, may be provided to one or more users, for example on user devices.

Therefore, a system provides a technical improvement over traditional methods for teaching students. Specifically, the described system and method provides a technique for producing a transcript from voice input received during a learning session. From the produced transcript, the transcript production system can perform an action with respect to the produced transcript. By creating transcripts from voice input provided during a learning session, the audible output is converted into a written format, which reduces errors that may occur when a student takes notes. Additionally, from the transcript, the system can perform actions that may allow a student to quickly access material at a later time. For example, the system can perform text recognition which allows a student to provide a search query into the system to find material instead of having to manually search for material as found in the traditional note-taking techniques, thereby saving a student a significant amount of time and effort in searching for content.

Additionally, the system can leverage artificial intelligence to tailor information taught in a learning session, as identified from the transcript, to individual needs of a student, thereby enhancing a learning session for each student individually, which is not feasible using traditional techniques that rely on teachers to expend significant time and effort. Additionally, with the use of the artificial intelligence models, a virtual assistant can be generated using the transcripts as a basis that can respond to input from students, thereby providing essentially a private tutor to students within a learning session, where the tutor is tailored to the needs of the student. Thus, the described system and method provides a significant improvement to the learning of students and traditional classroom environment.

The illustrated example embodiments will be best understood by reference to the figures. The following description is intended only by way of example, and simply illustrates certain example embodiments.

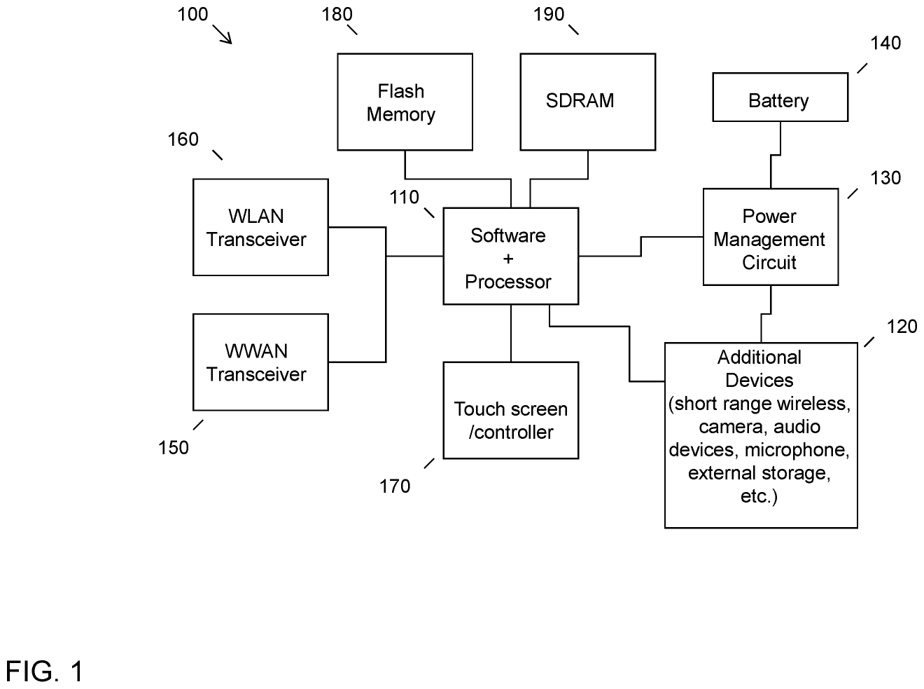

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

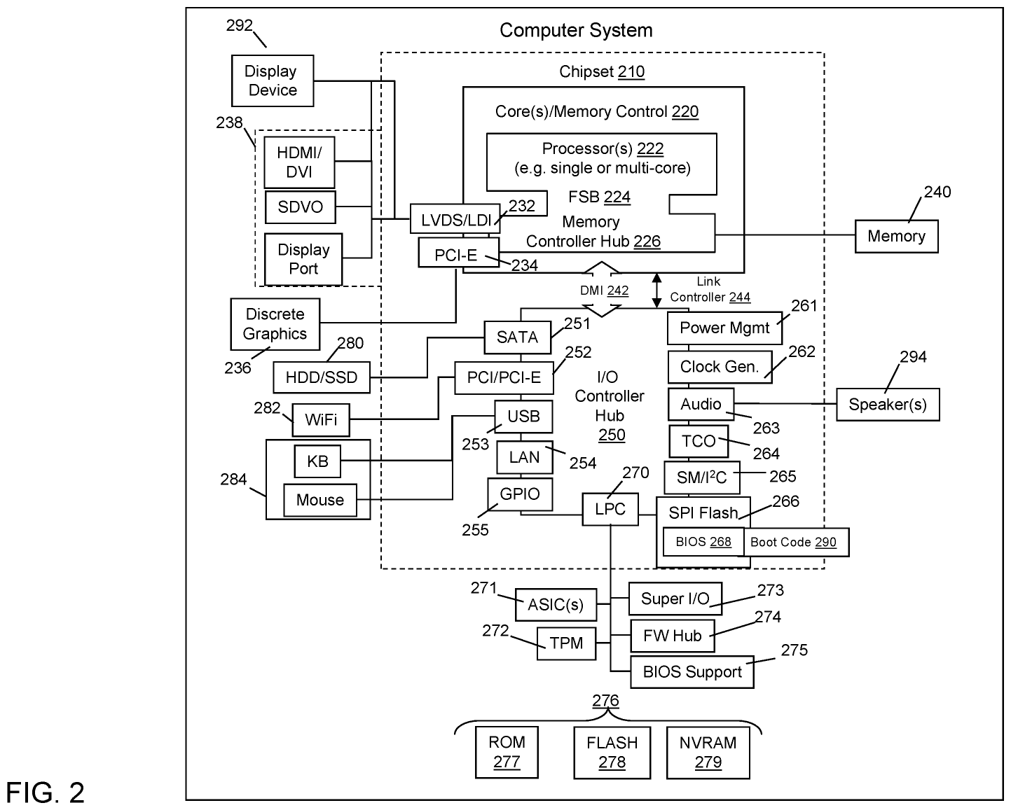

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used in devices or systems to produce a transcript from a voice input and perform an action with respect to the transcript as the transcript is produced. For example, the circuitry outlined in FIG. 1 may be implemented in a tablet or smart phone embodiment, whereas the circuitry outlined in FIG. 2 may be implemented in a personal computer embodiment.

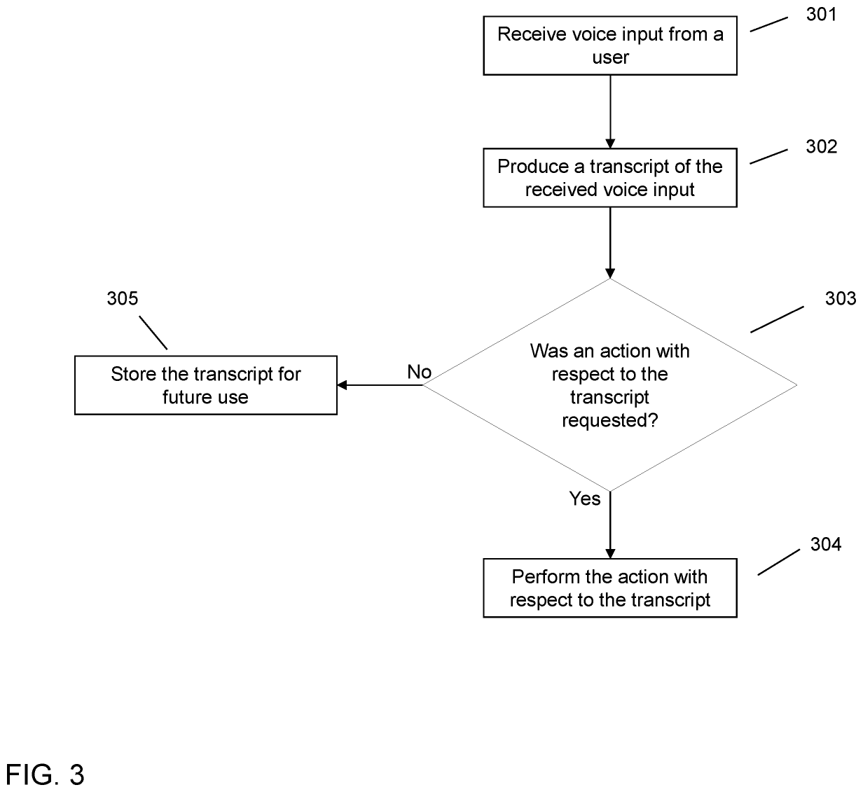

FIG. 3 illustrates an example method for producing a transcript of a received voice input and performing an action with respect to the transcript as the transcript is produced. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to produce a transcript from voice input as the voice input is received and perform an action with respect to the transcript. Additionally, the transcript production system includes modules and features that are unique to the described system.

The activation of the transcript production system may be manual, where a user provides an input indicating that the transcript production system should be activated, or automatic where the transcript production system detects a trigger event indicating that the system should be activated. Example trigger events include detection of the start of a learning session, detection of a particular person within a location (e.g., a teacher within a classroom, students within a classroom, a particular person within a classroom, etc.), activation of software or an application connected to or in communication with the transcript production system (e.g., application used to access a transcript, virtual assistant that provides assistance using the transcripts, an artificial intelligence model application, etc.), and/or the like. For example, the system may detect that a student has entered a classroom, identify this as a trigger event, and may thereafter activate the transcript production system. As another example, a user may provide a request to access a virtual assistant associated with the transcript production system, the system may identify this as a trigger event, and may thereafter activate the transcript production system.

The transcript production system may be a standalone system, may be accessible through other computing devices, and/or a combination thereof. For example, the transcript production system may be a standalone system that can be accessed by a user and/or may be or provide an application that is accessible by a user on another computing device. The transcript production system may be accessible using any type of computing device, for example, personal computer, laptop computer, smartphone, tablet, smartwatch, head-mounted display, smart television or other smart appliance, augmented reality device, virtual reality device, and/or the like. Thus, the transcript production system may be accessible locally using a computing device where the transcript production system is installed and/or may be accessible remotely through another computing device. For example, the transcript production system may be accessed by a user or other entity to access or modify transcripts, virtual assistants associated with the transcripts, artificial intelligence models, user profiles, transcript production system sensors or components, and/or the like. However, the transcript production system may be located and operate on a different information handling device to perform the described steps.

The transcript production system may have an associated graphical user interface. Additionally, a virtual assistant associated with the transcript production system may have an associated graphical user interface. The graphical user interface may be provided on a display or monitor, which may or may not be associated with the transcript production system. In other words, the transcript production system may have a dedicated display or monitor or may be accessible using any display or monitor. In either case, the transcript production system may provide instructions to generate and display the graphical user interface on the display device being used to access the transcript production system. The graphical user interface may also be updated and managed based upon instructions provided by the transcript production system. In other words, the transcript production system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the transcript production system. For example, the transcript production system may utilize a user profile to identify characteristics or preferences of the user (e.g., teacher, student, teaching assistant, tutor, educational therapist, etc.). The graphical user interface may allow for creation of this user profile by allowing a user to input information regarding the user, preferences of the user, and/or the like. As will be discussed in more detail, the use of user provided information is not the only way that the user profile can be created. The transcript production system can then utilize these inputs to create the user profile. A user could also use the graphical user interface to adjust information within the user profile.

As another example, the transcript production system may utilize a virtual assistant that is specific to the transcript production system. The graphical user interface may allow for programming, adjusting, training, or creation of the virtual assistant. An interface of the virtual assistant may also be modified for each user. Thus, the graphical user interface may provide input fields that allow the user to customize the virtual assistant per the preferences of the user. The virtual assistant may also be a default assistant interface. As will be discussed in more detail, the virtual assistant is able to respond to questions or queries posed by users through the use of artificial intelligence models. Thus, the graphical user interface may allow for providing information to program the virtual assistant, for example, identification of the models to be used, identification of locations of stored information and transcripts, and/or the like.

Additionally, or alternatively, the user can input a location housing or storing information related to a user profile, transcripts, artificial intelligence models, and/or the like, within the graphical user interface. Input may be provided by the user using any type of input modality, including, but not limited to, mechanical input (e.g., keyboard input, mouse input, etc.), touch input, audible or voice input, gesture input, haptic input, and/or the like. The graphical user interface may also provide displays that display information of the user profiles, virtual assistant, artificial intelligence models, transcripts, and/or the like. It should be noted that the information to be used by the transcript production system and information provided by the transcript production system can be different for different applications, different computing systems, different users, and/or the like. Thus, the information corresponding to input or output of the transcript production system are not always the same. However, the transcript production system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The transcript production system may utilize one or more artificial intelligence models in creating user profiles, training and deploying virtual assistants, analyzing transcripts, performing processes on transcripts, and/or any other steps included in the system or method. Artificial intelligence models may also be used for steps within a step. For example, a model could be utilized to perform audio analysis to produce a transcript of received voice input, to process transcripts to perform an action with respect to the transcript, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the transcript production system or may be a model that is created from scratch. Since the transcript production system is used in conjunction with producing transcripts and performing actions with respect to transcripts, some models that may be utilized by the system are large language models, text analysis models, image analysis models, audio analysis models, similarity identification models, filtering models, classification models, entity recognition models, and/or the like. The model may be trained using one or more training datasets. Additionally, as the model is deployed, it may receive feedback to become more accurate over time. The feedback may be automatically ingested by the model as it is deployed. For example, as the model is used to produce transcripts and perform actions with respect to transcripts, if a user identifies that a transcript was incorrect or an action was not performed correctly, or otherwise provides some indication that the predictions or selections made by the model may be incorrect, the model ingests this feedback to refine the model.

On the other hand, as the model is used to produce transcripts, perform actions with respect to transcripts, and/or the like, and no changes are made to the transcript, action performed with respect to a transcript, and/or the like, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The transcript production system may include different components for carrying out different functions of the system, including different steps to be performed. These components may be hardware components or software components. Some hardware components may include sensors (e.g., biometric sensors, image capture devices, proximity sensors, microphones, accelerometers, activity trackers, health metric sensors, etc.) that can be used to identify a user, identify a user is within a location (e.g., a teacher is within a classroom or other learning center, a student is within a classroom or other learning center, a teacher or student is near a device that utilizes or communicates with the transcript production system, etc.), identify gestures provided by a user, capture audio provided by a user, and/or the like. Other input devices may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the transcript production system. For example, the transcript production system may include speakers, displays or monitors, haptic output devices, audio output devices, and/or the like.

One software component, other than the artificial intelligence model(s), that may be utilized by the system is a user profile. A user profile may be associated with a student or a teacher. Within the teacher profile, the teacher may identify when transcripts are provided or made accessible to students, how often transcripts should be provided to students, whether students have the option to access all content of the teacher, whether students have the option to access secondary content, and/or the like. When a teacher allows students to access all content of the teacher, the students can not only access the transcript related to a particular topic, but can also access other content of the teacher that is related to the particular topic, for example, homework assignments, written notes of the teacher, content pulled from a secondary source and placed within the teacher content, historical content of the teacher, and/or the like. When a teacher allows access to secondary content, the student can not only access the transcript related to a particular topic, but can also access secondary content sources that is related to the particular topic. For example, the student may be able to access Internet sites that are related to the particular topic, materials from other teachers related to the particular topic, a transcript of another teacher related to the particular topic, and/or the like. The teacher may place limits or filters on the secondary content that is able to be accessed by the student. For example, the teacher may identify specific websites that can be accessed, instead of allowing access to all websites.

Within a student profile a student may set preferences for how a transcript might be utilized. For example, a student may want to receive transcripts of learning sessions. Within the user profile, the user may set how frequently the transcripts are received, what modality the transcripts are received in (e.g., written, audible, visual, etc.), a language the transcripts are received within, a formality the transcripts are received in, how the transcripts are communicated (e.g., saved to a data storage location, email communication, text communication, within an application associated with the transcript production system, etc.), and/or the like. For example, while a teacher may provide voice input in one language, a primary or first language of the student may be different than the language of the teacher. Thus, the student can provide input to the user profile regarding the fact that the primary language of the student is a particular language. The system may, when transmitting the transcript to the student, translate the transcript into the primary language of the student. Thus, the user profile may identify any characteristic of the user that can allow the system to provide transcripts in a manner that is most useful to the user.

It should be noted that other options and/or settings can be provided within the user profile, either a teacher profile or a student profile. Additionally, both the student and teacher profiles may have similar settings that may be applicable to both the teacher and student. On the other hand, the student and teacher profiles may have different settings when features are applicable to either the teacher or student. The user profile may be populated either through learning characteristics of the teacher and/or student or by a teacher and/or student manually providing input to the user profile, for example, using the graphical user interface. The system may learn characteristics of the teacher and/or student through the use of one or more artificial intelligence models and/or other learning algorithm. The user profile may also be populated with default values that can be changed either manually or through learning the characteristic. The default values may be true default values or may be somewhat customized to the user, for example, using historical information, utilized crowd-sourced information (e.g., using characteristics from other groups of users that have been identified as similar to the user, etc.), based upon correlations between one characteristic and another characteristic, and/or the like.

Another software component may be a data storage location where transcripts can be stored and accessed by the transcript production system for further use and/or analysis. As the transcripts are generated by the transcript production system, the transcript is stored within a data storage location. When the transcript is then requested by a user (e.g., teacher, student, other teachers, school administration, parents, etc.), the system can access the data storage location, obtain the correct transcript, and provide it to the requesting user (assuming the user is authorized to access the transcript). The transcript production system may also utilize the stored transcripts to perform other actions. For example, if the system translates the transcript from one language to another, the system may access the desired transcript and perform the necessary translation. The translated transcript may be stored within the data storage location along with the original transcript. Other actions may be performed and will be discussed in further detail herein.

At 301, the transcript production system receives voice input from a user. This voice input is generated during a learning session. Thus, the voice input may be from a teacher, presenter, tutor, student, and/or the like. The system may utilize sensors to capture the voice input, for example, microphones, or other audio capture devices. In addition, the system may use secondary sensors that may assist in deciphering the voice input. For example, the system may utilize cameras, electromyography sensors, and/or the like. The sensors and secondary sensors may be located throughout the learning environment, for example, around the room, on devices within the room, and/or the like. Thus, the sensors and secondary sensors may be located on standalone devices or components that are specifically designed to capture the information by the sensors, or may be located on other devices that include the sensors but that are not specifically dedicated to the sensors, for example, smart phones, smart watches, tablets, laptop computers, personal computer, and/or the like.

At 302, the transcript production system may produce a transcript of the received voice input. Producing the transcript may occur as the voice input is being provided. In other words, production of the transcript may occur in substantially real-time as the voice input is being provided. To produce the transcript, the system may utilize audio analysis techniques, artificial intelligence models, natural language processing techniques (e.g., parts of speech analysis, entity identification, syntactic analysis, semantic analysis, etc.), and/or the like, to identify words within the voice input and transcribe the words to a written format. The transcript production system may become more accurate over time, particularly when utilized to transcribe voice input of a particular person. In other words, the transcription can become more customized to a person over time and learn how a person says certain words and phrases, thereby becoming more accurate in generating the transcript.

When identifying words within the voice input, the system may assign a confidence to the transcription of the words or a series of words (e.g., phrase, sentence, paragraph, etc.). In other words, the system may identify how confident the system is with respect to an identification of a word within the voice input. If the confidence level assigned to a word or series of words is above a predetermined threshold, the system may continue on with transcribing additional words. However, if the confidence level assigned to a word or series of words is below the predetermined threshold, the system may attempt to increase the confidence level of the transcription of the word. Attempting to increase the confidence level may occur as the system is further transcribing additional words. In other words, even if the confidence level is below the predetermined threshold, the system does not stop transcribing additional words that are being provided in the voice input.

To increase the confidence level the system may perform secondary analysis or analyses. It should be noted that the system may also perform the secondary analysis on transcribed words even if the system does not assign a confidence level to words, if the assigned confidence level is above the predetermined threshold, and/or the like. In other words, the system may perform the analysis associated with increasing the confidence level of words even if the confidence level does not appear to necessitate the analysis. One type of secondary analysis includes utilizing context clues to increase the confidence level. By utilizing the natural language processing techniques, the system can identify entities within the voice input. Utilizing these entities, or other information gleaned from other natural language processing techniques, the system can identify a context of the word. The context may provide clues to a particular interpretation of a word or series of words within the voice input. Thus, the system may employ natural language processing techniques to assist in identifying words from the voice input. For example, the system may perform parts of speech analysis, semantic processing, syntactic processing, entity identification, and/or the like, in order to improve the accuracy and/or confidence of the transcription of the voice input.

Another type of secondary analysis includes utilizing the information obtained from the secondary sensors. The secondary sensors and information captured therefrom may be used by the system when producing a transcript of the received voice input. For example, the information captured by the secondary sensors may be useful in confirming an identification of a word or phrase that was identified from the voice input received at the audio capture device. In other words, when transcribing a word or phrase from the voice input, the system may utilize the information received from secondary sensors to confirm the accuracy or increase the confidence of the transcription process. For example, if the system identifies a word from the voice input, the system may confirm that word using images captured from an image capture device. In order to perform the analysis and identify information from the secondary sensors, the system may utilize artificial intelligence models, image analysis techniques, other sensor analysis techniques, and/or the like.

Another type of analysis includes utilizing historical transcripts and voice input to identify correlations between spoken words and properly transcribed words. This may be particularly useful if the historical transcripts and voice input are from the same user currently providing the voice input. However, this is not strictly necessary. In this case, the system can identify how a word was said in voice input and how it was ultimately transcribed, including any adjustments to the transcript made by the user. Additionally, even if the same word is not utilized, the system can identify inflections and ways that the person says particular word sounds. This information can be utilized by the system to identify words having similar word sounds. Other techniques for increasing the confidence or accuracy of the transcript are contemplated and possible, for example, utilizing crowd-sourced data which may include transcripts and voice input from users having similar characteristics to the user (e.g., same geographical region, same learning session subject or topic, same formality, etc.), requesting and receiving user input affirming or correcting a transcribed word, and/or the like.

Once the transcript has been produced, the transcript production system may determine if a specific action with respect to the transcript was requested at 303. The action may be requested either by direct input or request or through an indirect input or request. A direct input or request may include a specific request by a user to perform an action with respect to a transcript. For example, a user can provide a request that indicates the transcript should be summarized and the summary provided to the user. Thus, the system may identify an action based upon receipt of a user command and identifying the action from the user command. An indirect input or request may include a setting that triggers an action, a request received through an application that requires the system to perform some action with respect to the transcript to fulfill the request, and/or the like. For example, a user may have settings within the user profile that indicate that the transcript should be transmitted to all students upon completion of the learning session. Thus, when the system detects the learning session is complete, the system may transmit the transcript to each of the students. This transmission may include the performance of additional actions based upon other user settings.

If, at 303, the system determines that a specific action with respect to the transcript was not requested, the system may store the transcript for future use at 305. Storage of the transcript is an action performed by the system. However, this is the default action and not a specific action. Additionally, even if a specific action was requested, the system may also perform the action of storing the transcript. The transcript may be stored within a data storage location to be accessed at a later time. The access to the stored transcript may be upon request by a user to retrieve the stored transcript or may be in response to the system performing a different action with respect to the transcript. Within the data storage location, the system may also store altered transcripts or other information related to a stored transcript in a manner that allows the system to identify the transcripts and any related altered transcripts or other information. Altered transcripts or other information include transcripts in a different language, transcripts having a changed characteristic (e.g., formality, style, level of complexity, written voice, etc.), summaries of transcripts, identification of associated teacher content and location, identification of associated secondary content and location, and/or the like. In this case, the transcripts may not be provided in real-time to users. Instead, the users may access the transcript at a later time.

If, on the other hand, the system determines that a specific action with respect to the transcript was requested at 303, the system may perform the action with respect to the transcript at 304. The action may be performed as the transcript is produced. In other words, as the transcript is being produced, the system may also be performing the action. At the very least, the system will be performing the action of storing the transcript as the transcript is being produced. However, other actions may be performed as the transcript is produced. One action that may be performed as the transcript is produced is a dynamic altering of the transcript into an updated version. Dynamic altering of the voice input may be facilitated utilizing one or more artificial intelligence models.

Alteration of the transcript may be based upon input received by a user or based upon user settings or preferences within the user profile. In altering the transcript, the system may change the language of the transcript to one different than the language of the voice input, change the formality of the transcript as compared to the formality of the voice input, change the complexity of the transcript as compared to the complexity of the voice input, change a “voice” or style of the transcript as compared to the “voice” or style of the voice input, change words or phrasing of the transcript as compared to the words or phrasing of the voice input, and/or the like. This allows a user receiving the transcript to get a transcript in a version that may be more easily understood by the user than the voice input.

The system may also provide the updated version to a user device in real-time. This essentially means that as the voice input is being received, a user may be seeing the transcript on a user device at roughly the same time. The transcript being viewed by the user may be in a format or have characteristics as chosen by the user viewing the transcript. In other words, the viewed transcript may be the dynamically altered transcript.

Another action that may be performed is summarizing content within the transcript. The system can utilize natural language processing techniques and summarization techniques to summarize content within the transcript. Essentially, the system can identify the topic and then identify points that are encompassed within the topic. Using this information, the system can generate a natural language summary of the transcript including the topics and points encompassed within the topics. The system may also, or instead, use artificial intelligence model(s) to generate the summary. The length of the summary can vary and may be based upon preferences provided by a user. The summary may be provided with the transcript or may be provided in place of the transcript.

The system may also identify a topic contained within a transcript and display, on a user device, secondary content related to the topic and obtained from a secondary source. In this context, secondary content includes teacher content. The system may identify a topic within the transcript and may, either without prompting or upon receive of user input to do so, query a secondary source (e.g., Internet, teacher content, content from other teachers, etc.) with the identified topic, or sub-topic, and display the results of the query on the display device. What secondary sources may be queried may be restricted or identified by the teacher profile. For example, the teacher may indicate that content other than the Internet may be queried. As another example, the teacher may allow Internet content but may restrict the websites that are accessed. Restricting the websites may include identifying specific websites that can be accessed, identifying top-level domain names that can be accessed, identifying websites or top-level domain names that cannot be accessed, and/or the like.

The user may provide input to the displayed content, which may result in additional actions being performed. For example, a user can provide input that indicates the user wants to see more results “like this,” the user wants to expand the result and view the full content, the user wants to remove a result, the user wants the system to provide an audible output of the result, and/or the like. The user can also provide notes to the displayed content. These notes may thereafter be saved for the user and accessible at a later time. Similarly, the user may save one or more of the displayed content to be displayed when the user accesses the transcript or the topic at a later time. The identification of secondary content may be facilitated utilizing one or more artificial intelligence models.

Another action that may be performed is providing the transcript to one or more artificial intelligence models. These models can perform many different actions on the transcript, including some previously discussed. The artificial intelligence model(s) can be utilized to create a virtual assistant or chat user interface. This virtual assistant may be provided to users. Within the virtual assistant interface, the user may provide queries or requests for information. The virtual assistant may respond to the queries or requests for information facilitated via the one or more artificial intelligence models. In other words, the one or more artificial intelligence models can ingest the transcripts. Upon receiving a query from the user at the virtual assistant, the artificial intelligence model can parse the query, identify the information being requests, identify the information from the transcript(s), and provide a response to the query via the virtual assistant. The virtual assistant can provide functions such as identifying and providing a transcript where a particular topic was discussed, summarizing content within a transcript, guide or instruct students regarding a particular topic based upon the transcripts, find additional content related to a particular topic, providing information to a student who missed a learning session, and/or the like.

It should be noted that the system can perform many different actions on the transcript at the same time. For example, each student within a learning session may want a different action performed. Additionally, some students may want more than one action performed on the transcript. The system can facilitate performance of all of these actions at the same time. Thus, a combination of actions can be performed on the transcripts.

As an overall non-limiting example of the described system, a teacher is teaching a classroom of students during a learning session. As the teacher is providing voice input, the transcript production system is capturing the voice input and transcribing the voice input into a transcript. In this example, this transcription process occurs in substantially real-time as the voice input is being received. While the transcript is being produced, the system can also perform an action with respect to the transcript. One example action may be providing the transcript, as it is being produced, to the students during the learning session. In the case where the student has a different primary language than the teacher, for example, the student's primary language is Spanish and the teacher is providing the voice input in English, when the transcript is provided to the student it is provided in Spanish, or whatever the student's preferred language is. Other modifications can be made to the transcripts including the formality of the transcript as compared to the voice input, a style of the transcript as compared to the voice input, a level of detail of the transcript as compared to the voice input, characteristics of the transcript as compared to the voice input, and/or the like.

After the teacher is finished teaching, for example, at the end of the lesson, after the students leave the classroom, and/or the like, the students can access not only the transcripts, but also a digital assistant which is specifically programmed to be responsive to queries based upon the transcripts. The digital assistant is made possible using artificial intelligence models that are trained using the transcripts and are trained to be able to identify content within the transcripts. Thus, when the student has a question, the student can access the digital assistant and query the digital assistant with the question. Depending on the question, the digital assistant can provide a variety of output. For example, the digital assistant may identify where a particular topic is within the transcripts, may provide a summary of a transcript, may provide other teacher content related to a particular topic, may provide secondary content related to the particular topic, and/or the like. The digital assistant can provide the output in different modalities, depending on the preference of the student. For example, the digital assistant may provide visual output, written output, graphical output, audible output, gesture output, video output, and/or the like.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
receiving, at a transcript production system, voice input, generated during a learning session, from a user;
producing, from the received voice input and utilizing the transcript production system, a transcript of the received voice input; and
performing, utilizing the transcript production system, an action with respect to the transcript as the transcript is produced.

2. The method of claim 1, wherein the producing is performed in real-time as the voice input is provided.

3. The method of claim 2, wherein the performing an action comprises dynamically altering the transcript into an updated version of the transcript and providing the updated version to a user device in real-time.

4. The method of claim 1, wherein the performing an action comprises identifying an action from a user command received.

5. The method of claim 1, wherein the performing an action comprises translating the transcript to a language different than the transcript produced from the received voice input.

6. The method of claim 1, wherein the performing an action comprises providing the transcript to an artificial intelligence model.

7. The method of claim 6, comprising generating a virtual agent that utilizes the artificial intelligence model to respond to input provided by a user.

8. The method of claim 6, wherein the performing an action comprises dynamically altering, using the artificial intelligence model, the transcript of the voice input into an updated version having different characteristics than the transcript.

9. The method of claim 1, wherein the performing an action comprises identifying a topic contained within the transcript and displaying, on a user device, secondary content related to the topic and obtained from a secondary source.

10. The method of claim 1, wherein the performing an action comprises summarizing content contained within the transcript.

11. A system, the system comprising:
sensors located at a secure location;
a processor operatively coupled the sensors;
a memory device that stores instructions that, when executed by the processor, causes the system to:
receive, at a transcript production system, voice input, generated during a learning session, from a user;
produce, from the received voice input and utilizing the transcript production system, a transcript of the received voice input; and
perform, utilizing the transcript production system, an action with respect to the transcript as the transcript is produced.

12. The system of claim 11, wherein the producing is performed in real-time as the voice input is provided.

13. The system of claim 12, wherein the performing an action comprises dynamically altering the transcript into an updated version of the transcript and providing the updated version to a user device in real-time.

14. The system of claim 11, wherein the performing an action comprises translating the transcript to a language different than the transcript produced from the received voice input.

15. The system of claim 11, wherein the performing an action comprises providing the transcript to an artificial intelligence model.

16. The system of claim 15, comprising generating a virtual agent that utilizes the artificial intelligence model to respond to input provided by a user.

17. The system of claim 15, wherein the performing an action comprises dynamically altering, using the artificial intelligence model, the transcript of the voice input into an updated version having different characteristics than the transcript.

18. The system of claim 11, wherein the performing an action comprises identifying a topic contained within the transcript and displaying, on a user device, secondary content related to the topic and obtained from a secondary source.

19. The system of claim 11, wherein the performing an action comprises summarizing content contained within the transcript.

20. A product, the product comprising:
a computer-readable storage device that stores executable code that, when executed by a processor, causes the product to:
receive, at a transcript production system, voice input, generated during a learning session, from a user;
produce, from the received voice input and utilizing the transcript production system, a transcript of the received voice input; and
perform, utilizing the transcript production system, an action with respect to the transcript as the transcript is produced.
